(19) United States
(12) Patent Application Publication
(10) Pub. No.: US 2013/0276023 A1
(43) Pub. Date: Oct. 17, 2013

(54) Serving Advertisements to a First Device Based on Interactions on a Second Device

(71) Applicants: James KENT, London (GB); Timbo Drayson, London (GB)

(72) Inventors: James KENT, London (GB); Timbo Drayson, London (GB)

(73) Assignee: Google Inc., Mountain View, CA (US)

(21) Appl. No.: 13/445,829

(22) Filed: Apr. 12, 2012

(51) Int. Cl. H04N 21/458

(52) U.S. Cl. 725/34; 725/32

(57) ABSTRACT

A method, and a system, supplies advertising by associating advertisements to be displayed on a first media device with actions occurring on a second media device, the first media device having a unique identification. The method includes receiving from the second media device, the unique identification of the first media device; receiving an action from the second media device, the action generated during execution of an application; determining an advertisement to serve to the first media device based at least in part on the UID received from the second media device; and serving the advertisement to the first media device.

### BACKGROUND

In today's television viewing experience, many individuals employ multiple media devices simultaneously, such as watching television programming on a traditional television while surfing the Web on a tablet, computer, or smart phone. The individual may receive advertisements on one or more of the multiple media devices.

### DESCRIPTION OF THE DRAWINGS

The detailed description will refer to the following figures, in which like numerals refer to like items, and in which:

FIG. 1A illustrates an embodiment of an environment in which advertisements presented on a first device are based on interactions on a second device;

FIG. 1B illustrates an embodiment of an alternate environment in which advertisements presented on a first device are based on interactions on a second device;

FIG. 2 illustrates an embodiment of components of media devices used in the environments of FIGS. 1A and 1B;

FIG. 3 illustrates an embodiment of a software system distributed among the components of FIG. 1B; and

FIGS. 4A and 4B are flow charts illustrating embodiments of methods for presenting advertisements on a first device are based on interactions on a second device.

### DETAILED DESCRIPTION

In today's television viewing experience, many individuals employ multiple media devices simultaneously, such as watching television programming on a traditional television while surfing the Web on a tablet, computer, or smart phone. This means, however, that advertisements presented on the multiple media devices may not be effective because the advertisements do not take into account this multi-device usage.

Disclosed herein is a system, and corresponding method, in which advertisements presented on a first device are based on interactions of an individual with, or content provided on, a second device. In an embodiment, the system includes an advertiser who provides advertisements for display on a first media device, such as a television (e.g., an intelligent, Internet-connected television (iTV)), to a trafficking server. The iTV may be connected to a set top box (STB) or may have the functions of a STB incorporated into a processor internal to the iTV. Thus, the iTV may be one of a television with integrated electronics for connection to a network as well as a basic television connected to a box (e.g., a set top box, a program receiving unit, a digital video recorder, a web connected box, etc.) that itself connects to the network. The advertiser may provide the advertisement content (creatives) and determine and provides the criteria for display of the advertisement. The trafficking server may send the advertisement to an ad server with instructions for display of the advertisement.

In a same viewing environment or location, an individual may operate a second media device, which may be a tablet, smart phone, lap top computer or desk top computer, for example. The second media device includes the hardware and software components to record or receive signals from or on the iTV or from a box connected to a television.

In an example, the signals are audio signals sent from the iTV or the STB. The audio signals may be outside the range of human hearing. The audio signals provide a unique identification (UID) that identifies the ITV or STB.

In another example, the signals are video signals. The video signals may be out-of-band video signals. Alternately, the video signals may include a visible code displayed on a screen of the iTV. Whether visible, nearly invisible, or invisible to the human eye, the video signals may encode the UID and other information. The video signals may constitute a two-dimensional bar code, for example. The video signals may be useful in situations where an audio signal does not work, such as in an area with a noisy background, or when the ITV is muted.

In yet another example, both audio and video signals are used.

The second media device decodes the UID, generates a digital file containing the decoded UID, and sends the digital file to the ad server. For example, the second media device may include a microphone to acquire an audio signal and a camera or similar video capture device to acquire a video signal. The second media device further may include an application to decode the acquired signal, generate the digital file, and send the digital file to the ad server.

When the individual using the second media device performs an action requiring an advertisement, the second media device sends the decoded UID, and a trigger, to the ad server. As used herein, the trigger may be the result of a keystroke, pushing a button, use of a touch-sensitive screen feature, use of a navigation device, and use of a voice-activation feature, for example, on the second media device. In some cases, the action may include the display of particular content or media. An action may be the response of an individual to external stimuli. Examples of actions include accessing a Web site, navigating pages of a Web site, acquiring a product from a Web site, executing an application on the second media device, changing programs or applications on the second media device, and signaling acceptance of an offer displayed on the iTV using a selection feature on the second media device. The ad server determines which advertisement, out of its collection of advertisements, should be sent to the ITV or STB. When the ITV or STB requests an advertisement, the iTV or STB includes in the request, its UID. Upon receipt of the advertisement request, an advertising engine determines which advertisement would best match the actions associated with the advertisement requests, and the link between the iTV or STB on the one hand, and the second media device (e.g., tablet) on the other hand.

The systems and methods disclosed herein may use information related to a specific individual or device. For example, an individual may register with an Internet service provider, a content provider, an advertiser, or similar service entity and may, at least initially, provide personally-identifiable information such as name and address. However, to protect the individual's privacy, the systems and methods may use other “anonymized” information, such as the IP address of a device, a user name provided by the individual, or other anonymous information that sufficiently identifies the individual or device without compromising the individual's privacy. Furthermore, the systems and methods may provide for the individual to opt in or opt out of a specific aspect of a service at any time. For example, the individual may opt out of a service that collects advertisements watched information.

A media device may send, with the consent of the individual (e.g., via opt out, opt in, or anonymization) identification (ID) information to the server that identifies the media device and/or the individual. One aspect of sending the information includes a media device signing on with a service. In some cases, the device may automatically sign on using previously provided and stored credentials or other automatic information. Any personally-identifiable information that may be provided by the individual is made anonymous in the system. The anonymized information may include cookies, user/device identifiers, or other abstractions of, the user's actual identity.

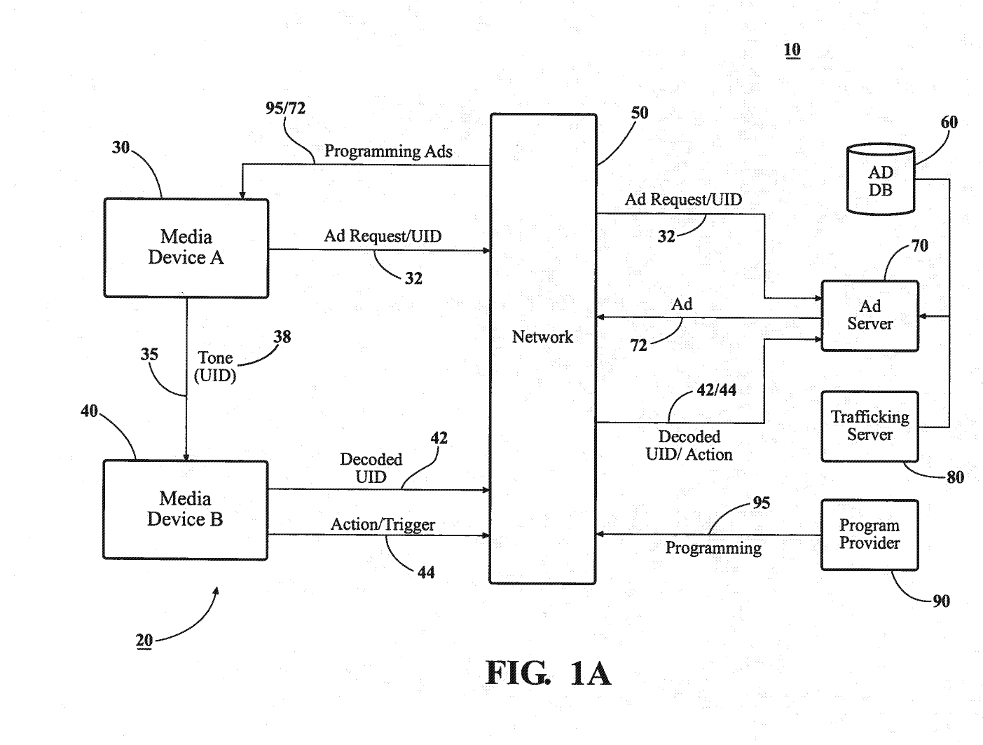

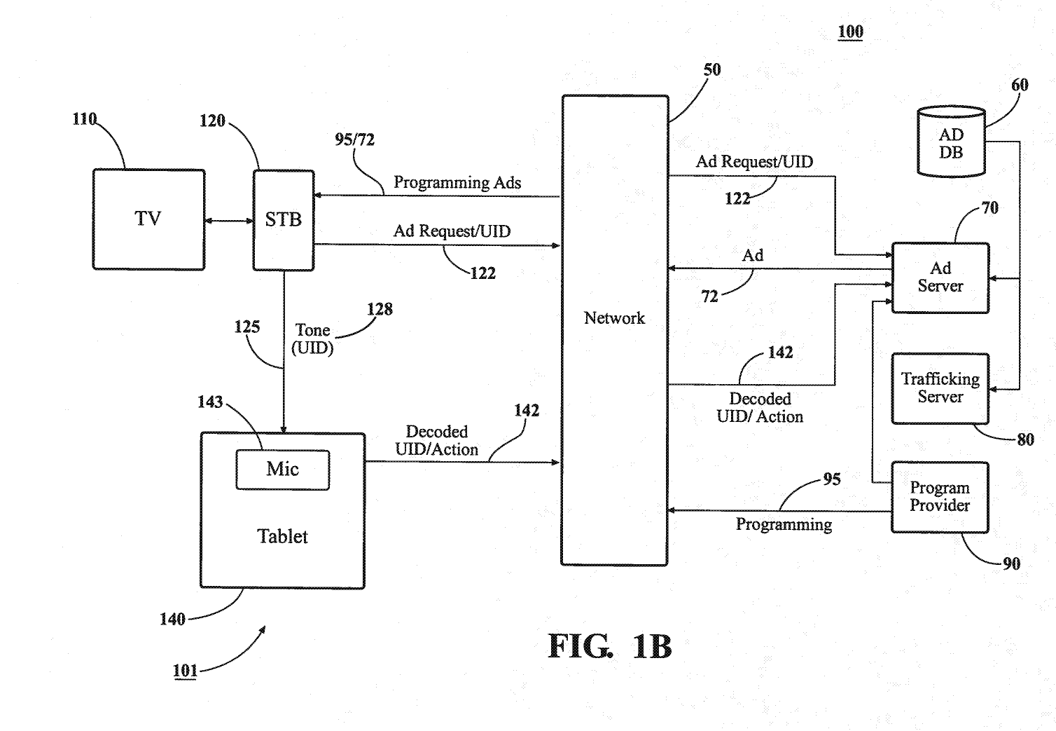

FIG. 1A illustrates an embodiment of an environment in which advertisements are supplied or targeted to a first device based on actions on a second device. In FIG. 1A, environment 10 includes a first media device A 30 and a second media device B 40 located at viewing location 20. The viewing location 20 may be a room in a house, a hotel room, or a public area such as a lounge at an airport. An individual at the viewing location 20 is able to view and interact with both the media devices 30 and 40. In one alternative, the media device 30 is an Internet-connected “smart” television (iTV). In another alternative, the media device 30 is a “basic” television that is coupled to a program receiving unit equipped with a separate processor, such as a set top box (STB) or satellite box. In yet another alternative, the media device 30 is an ITV coupled to a program receiving unit. Other configurations for the media device 30 are possible. The media device 40 is, in an alternative, a mobile device such as a tablet, smart phone, lap top computer, or other mobile or portable device. The media device 40, in another alternative, is a desk-top computer or other fixed device. The media device 40 and the media device 30 are capable of communicating with each other over communications path 35. Communications path 35 may be wired or wireless, and includes WiFi, infrared, and “broadcast.” Otherwise, the media devices 30 and 40 are “independent” of each other; that is, the operation of one does not depend on the operation of the other.

The media devices 30 and 40 are coupled to network 50, which may be any communications network that allows the transmission of signals, media, messages, voice, and data to the viewing location 20 including radio, linear broadcast (over-the-air, cable, and satellite) television, on-demand channels, over-the-top media, including streaming video, movies, video clips, and games, and text, email, and still images, and transmission of signals media, messages, voice, and data from the media devices 30 and 40. The network 50 includes the Internet, cellular systems, and other current and future mechanisms for transmission of these and other media. The network 50 may be both wired and wireless.

Also coupled to the network 50 are devices, remote from the viewing location 20, that are capable of sending content in the form of programming and advertisements to the media devices 30 and 40. The remote devices include advertisement (ad) server 70, trafficking server 80, and program provider 90. In FIG. 1A, program provider 90 combines the functions of program provider and program distributor (i.e., broadcaster, Web host). The program provider 90 provides programming 95 for display at either of the media devices 30 and 40. The programming 95 includes radio, linear broadcast (over-the-air, cable, and satellite) television, on-demand channels, over-the-top media, including streaming video, movies, video clips, and games, and text, email, and still images. The program provider 90 may include an Internet service provider (ISP) and an email service. The program provider 90 may be coupled directly (not shown in FIG. 1A) to the ad server 70 and receives advertisements from the ad server 70.

The ad server 70 is operated by an advertiser, and provides advertisements 72 for incorporation into the programming 95. Certain of the advertisements selected by the trafficking server 80 are “ITV-schedule,” or “targeted” advertisements. In general, iTV-schedule advertisements are targeted to individuals or to groups of individuals. Such targeting may be based on geographic location, demographics, specific programs (content) included in the programming, viewing history of the individual, including Internet Web sites visited, other individual behaviors such as program preferences as provided explicitly by the individual, the type and make of the media device, and time and date, among other factors.

The advertiser acquires the advertisements, including targeted advertisements, determines under what circumstances targeted advertisements are to be displayed, uploads the advertisement creatives to advertisement database 60, and sets the criteria for display of a targeted advertisement. The advertiser may target advertisements for display on the media device 30 based on specific actions taken on, or applications executing on, a mobile media device, such as the media device 40. For example, the advertiser may target an advertisement for a resort hotel chain when the mobile device 40 is executing an application for an airline reservation system. The trafficking server 80 provides specific instructions regarding such targeting to the ad server 70. In the absence of targeting instructions, the ad server 70 may provide a default advertisement, or an advertisement selected using other criteria.

The trafficking server 80 also accesses database 60 to select and schedule advertisements for display with the programming 95. The trafficking server 80 loads the database 60 with information related to media devices and types of individual behaviors that merit targeting of advertisements. The trafficking server 80 sends the selected advertisements to the ad server 70 for distribution over the network 50.

In the environment 10 of FIG. 1A, the media device 30 broadcasts tone 38 through speakers (not shown) of the media device 30. The tone 38 includes a unique identification (UID) that specifically identifies the media device 30. The tone 38 may be an audible tone that is outside the range of hearing of humans, but is detectable by the media device 40 using a microphone and an application (not shown in FIG. 1A). The tone 38 may be emitted continuously or periodically. The media device 40 receives the tone 38 and processes the tone 38 using an application to decode the UID.

The media device 40 sends decoded UID 42 to the ad server 70, which notifies the ad server 70 that the media device 40 is operating in the vicinity of the media device 30. Alternately, the decoded UID 42 is stored in the media device 40 for later transmission to the ad server 70. When the media device 40 initiates an action associated with delivering an advertisement, with the prior consent of the user of the media device 40, the action/trigger 44 and the UID 42 are sent to the ad server 70, where the action/trigger 44 and UID 42 are stored. In an embodiment, the media device 40 includes a background application that determines when an action is taken, at the media device 40, that should be reported to the ad server 70. For example, the individual may use the media device 40 to access and navigate a Web site for an automobile manufacturer, “construct” a car, request the location of the nearest dealer, and download a product brochure. The step of downloading the brochure may be a “reportable” action.

When the media device 30 is scheduled to display an advertisement (e.g., during a programming break in a broadcast television program), the media device 30 sends an advertisement request/UID 32 to the ad server 70. The advertisement request/UID 32 may include the channel the media device 30 is tuned to. The ad server 70 may compare the UID 42 and action/trigger 44 previously received to the advertisement request/UID 32 as part of its logic for selecting the “correct” advertisement to supply to the media device 30. The selection logic further considers the specific action, the channel, and other information for selecting the advertisement. Finally, the logic compares the received information to criteria set by the advertiser, and if the criteria are met, the ad server 70 provides an iTV advertisement to the media device 30. If the criteria are not met, the ad server 70 provides a default advertisement to the media device 30.

FIG. 1B illustrates another environment in which advertisements are targeted to a first media device based on actions taken at a second media device. In FIG. 1B, environment 100 includes media devices located at viewing location 101. These media devices communicate with remote servers through network 50. The remote servers include ad server 70, trafficking server 80, and program provider 90. The ad server 70 and trafficking server 80 are coupled to advertisement database 60. These remote servers operate as described above with respect to FIG. 1A.

At the viewing location 101, the first media device includes television (TV) 110, which is coupled to set top box (STB) 120. The STB 120 receives programming 95 and advertisements 72 through the network 50 for display on the TV 110. The STB 120 broadcasts a tone, outside the range of human hearing, over communications path 125. The tone includes an identification UID 128 that uniquely identifies the STB 120.

The second media device may be a mobile device. In the illustrated example, the second media device is tablet 140. The tablet 140 includes microphone 143 to receive the tone broadcast by the STB 120. The tablet 140 also includes a background application that decodes the tone to produce the UID 128, and to store and transmit the UID 128 to the ad server 70 at an appropriate time. The background application also monitors actions taken on the tablet 140 to determine if any of the actions constitutes a reportable action. After the tablet 140 identifies an action as a reportable action, the tablet 140 sends the UID and reportable event as decoded UID/action message 142 to the ad server 70. The tablet 140 may send the message 142 immediately upon identifying the action as a reportable event, or at some time subsequent.

The STB 120 determines when an advertisement should be scheduled and sent for display on the TV 110. When this determination is made at the STB 120, the STB 120 sends an advertisement request message 122 to the ad server 70. The advertisement request message includes the STB's UID, the advertisement request, and the channel to which the STB is tuned.

When the ad server 70 has received the messages 122 and 142, the ad server 70 executes a program to determine if the advertisement to be sent to the STB 120 should be a targeted advertisement or a default advertisement. The program logic for determining whether to serve a targeted advertisement was described previously with respect to FIG. 1A.

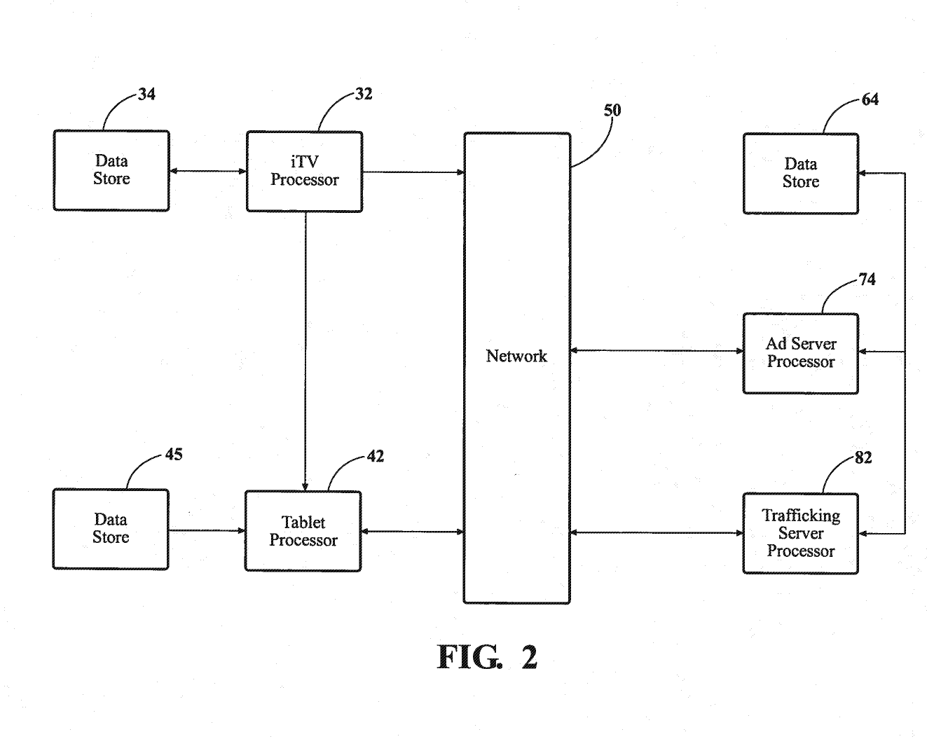

FIG. 2 illustrates an embodiment of components used by the various servers and media devices of FIGS. 1A and 1B. In FIG. 2, iTV processor 32 is coupled to ITV data store 34. The iTV processor 33 executes programming stored in a database loaded onto the data store 34. Mobile device processor 42 is coupled to data store 45. The mobile device processor 42 executes programming stored in a database loaded onto the data store 45. Ad server processor 74 and trafficking server processor 82 are coupled to data store 64. The data store 64 is loaded with the database 60. The processors 74 and 82 access and execute programming stored in the database 60. The data stores 34, 45, and 64 are computer readable storage media.

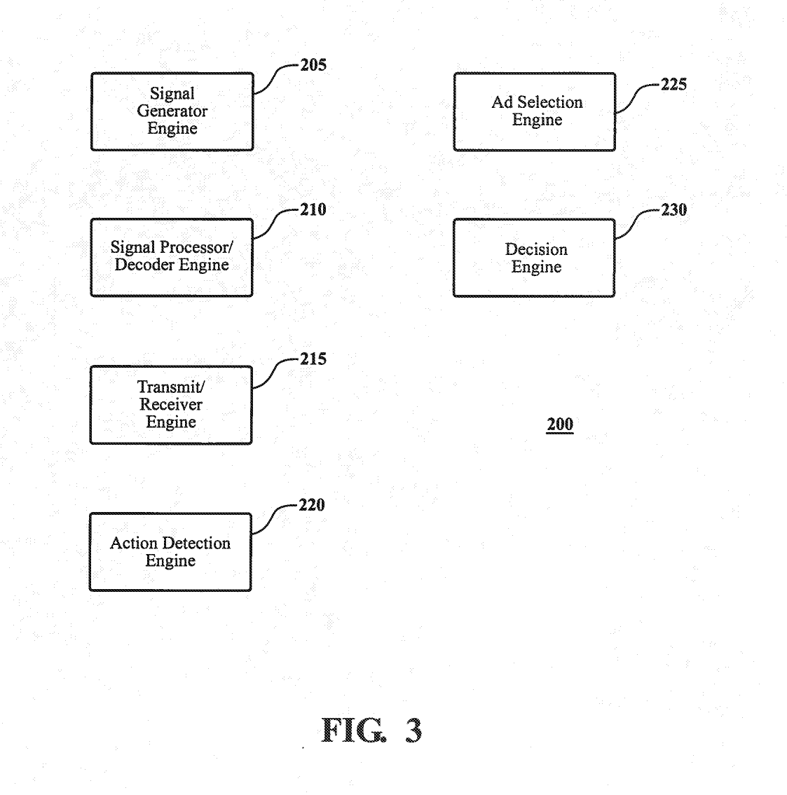

FIG. 3 is a block diagram illustrating selected elements of a software system of machine executable code that is distributed among certain of the components shown in FIG. 2. In FIG. 3, software system 200 includes signal generator engine 205, signal processor/decoder engine 210, transmit/receive engine 215, action detection engine 220, ad selection engine 225, and decision engine 230.

The signal generator engine 205 resides in the data store 34, and is executed by the processor 32 of the first media device 30 to broadcast a tone providing the UID of the first media device 30. The signal processor/decoder engine 210 resides in the data store 45 and is executed by the processor 42 of the second media device 40 to receive the broadcast tone, decode the broadcast tone to extract the UID, and to store the extracted UID.

The transmit/receive engine 215 resides in the data stores 34, 45, and 64, and is used by the processors 32, 42, 74, and 82 to receive and decode incoming messages, and to format and transmit outgoing messages.

The action detection engine 220 resides in the data store 45 and is used by the processor 42 to detect actions executed on the second media device 40, to determine if the detected actions are reportable events, to store the actions that are determined to be reportable events, and to format those actions for inclusion in a UID/action message that is sent to the ad server 70. The action detection engine 220 operates in the background of the second media device 40. In an embodiment, the action detection engine 220 performs the action detection, determination, and reporting functions when specifically authorized by the individual using the second media device 40. For example, upon startup of the second media device 40, the action detection engine 220 may present a display to the individual asking the individual to accept or decline the functions of the action detection engine 220. If the individual declines, then the other elements of the software system 200 residing in the data store 45 may not be executed.

The ad selection engine 225 and the decision engine 230 reside in the data store 64 and are executed by the processor 74. The ad selection engine 225 includes logic to select the optimum targeted advertisement to serve to the media device 30 based on the UID received from the media device 40, the action reported by the media device 40, and the advertisement request and channel information provided by the media device 30. For example, an action of requesting a location of a nearest automobile dealer might narrow the targeted advertisements to those related to new car sales. Finally, the program being watched is used to provide another input as to the advertisement to serve to the media device 30.

The decision engine 230 retrieves the criteria set by the advertiser for the selected targeted advertisement and compares information related to the media devices 30 and 40 to determine if the provided criteria are met. If the criteria are met, the decision engine 230 instructs the ad server 70 to serve the selected targeted advertisement. Otherwise, the decision engine 230 instructs the ad server 70 to serve a default advertisement Finally, if a targeted advertisement is sent to the media device 30, the decision engine 230 may instruct the ad server 70 to store the associated, reported action as an ad impression.

In an alternate to embodiment of the software system 200 shown in FIG. 3, the advertisement selection and decision functions of the engines 225 and 230 are included in the data store 45 accessible to the processor 42. In this alternative embodiment, media device 30 signals by broadcast, what channel the media device 30 is tuned to, and the media device 40 acquires the channel broadcast signal. The media device 40 determines which targeted advertisement, from a database of such targeted advertisements residing on the data store 45, should be displayed on the media device 30. The ad selection engine 225 selects one of the stored advertisements, and the decision engine 230 determines if the criteria for that advertisement, as set by the advertiser are met. If the criteria are met, the media device 40 provides the advertisement of the media device 30 for display. If the criteria are not met, the media display device 30 plays a default advertisement provided by the ad server 70.

Instead of serving a targeted advertisement from the media device 40 when the criteria are met, the media device 30 may store advertisements in the data store 34, and the media device 40 simply signals the media device 30 to display one of the stored targeted advertisements. The signal from the media device 40 may specify which of the advertisements stored in the data store 34 is displayed.

In still another embodiment of the software system 200 shown in FIG. 3, the advertisement selection and decision functions of the engines 225 and 230 are included in the data store 34 accessible to the processor 32. In this embodiment, the data store 34 also stores targeted advertisements for display on the media device 30. The media device 40 may signal the occurrence of an action to the media device 30, and the advertisement selection and decision functions are executed in the processor 32.

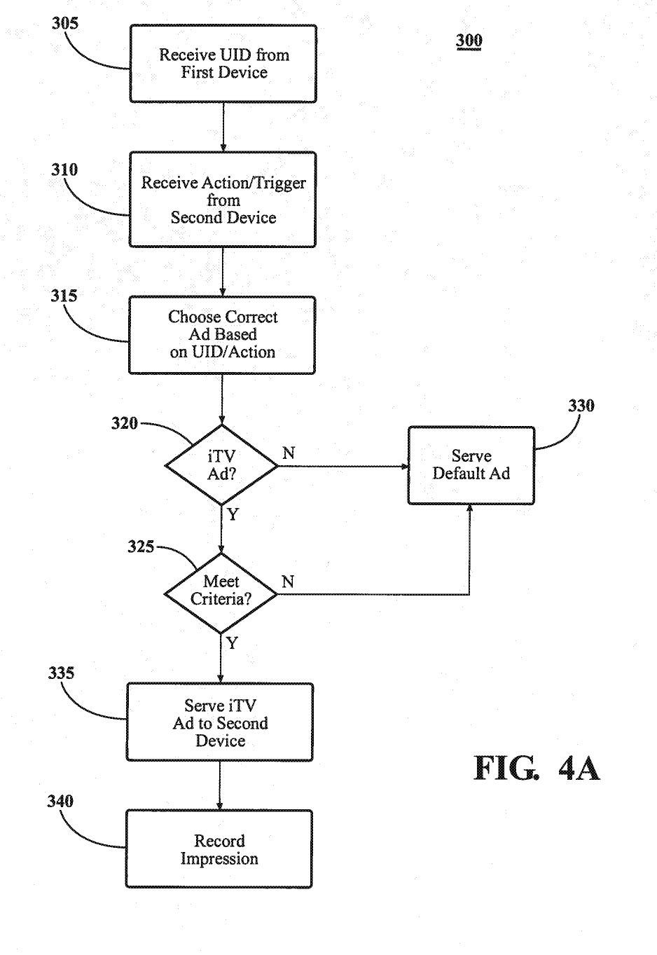

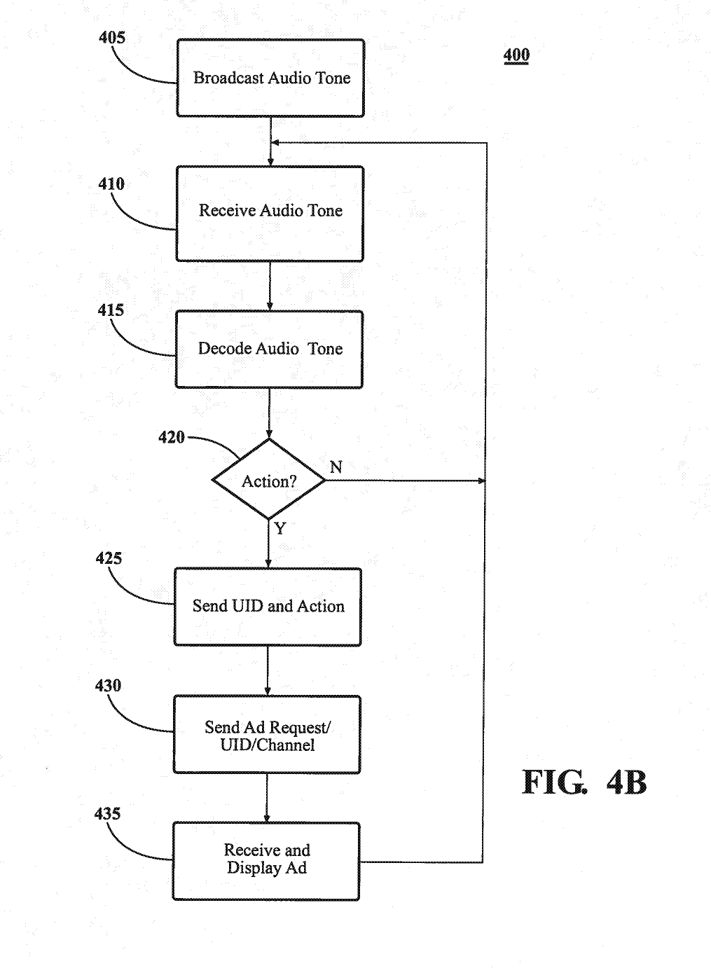

FIGS. 4A and 4B are flow charts illustrating embodiments of methods for targeting advertisements to a first media device based on interactions at a second media device. In FIG. 4A, method 300 begins in block 305 when the ad server 70 receives a UID and a reportable action from the media device 40. In block 310, the ad server 70 receives an advertisement request, UID, and channel from the media device 30. The ad server 70 may identify the location of the second media device from the UID, assuming the second media device is registered, or the individual has entered address location for the media device 30. In block 315, the ad server 70 chooses a targeted advertisement for display at the media device 30 based on the received UID and channel from the media device 30, and the reported action from the media device 40. In block 320, the ad server 70 determines if a targeted advertisement should be served. If not (N), the method 300 moves to block 330. If yes (Y) in block 320, the method 300 moves to block 325, and the ad server 70 determines if the criteria provided by the advertiser is met by the selected targeted advertisement, and the media device 30. If the criteria are not met (N), the method 300 moves to block 330. In block 330, the ad server 70 provides a default advertisement for display on the media device 30.

If, in block 325, the ad server 70 determines the criteria are met, the method 300 moves to block 335, and the ad server 70 provides the advertisement selected during execution of blocks 315 and 320 to the media device 30. In block 340, the ad server 70 records the reported action as an impression.

FIG. 4B is a flow chart illustrating alternative method 400 for targeting advertisements to a first media device based on actions reported from a second media device. In FIG. 4B, media device 30 broadcasts, block 405, an audio tone that is detected, block 410, by media device 40. The media device 40 decodes and processes, block 415, the tone to extract the UID of the media device 30.

In block 420, the media device 40 executes an action, and the action detection engine 220 determines if the action is reportable; i.e., associated with a displayed advertisement. If the action is not reportable, the method 400 returns to block 410. If the action is reportable, the method moves to block 425, and the media device 40 sends the UID and the action to the ad server 70.

In block 430, the media device 30 sends an advertisement request, the UID, and the channel to the ad server 70. In block 435, the media device 30 receives and displays an advertisement from the ad server 70. The received advertisement may be a default advertisement or a targeted advertisement. The method 400 then returns to block 410.

Certain of the devices shown in FIGS. 1A and 1B include a computing system, components of which are shown in FIG. 2. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which may store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device may include one or more of a number of output mechanisms. In some instances, multimodal systems enable a user to provide multiple types of input to communicate with the computing system. A communications interface generally enables the computing device system to communicate with one or more other computing devices using various communication and network protocols.

The above disclosure refers to a number of flow charts and accompanying descriptions to illustrate the embodiments represented in FIGS. 4A and 4B. The disclosed devices components, and systems contemplate using or implementing any suitable technique for performing the steps illustrated in these figures. Thus, FIGS. 4A and 4B are for illustration purposes only and the described or similar steps may be performed at any appropriate time, including concurrently, individually, or in combination. In addition, many of the steps in these flow charts may take place simultaneously and/or in different orders than as shown and described. Moreover, the disclosed systems may use processes and methods with additional, fewer, and/or different steps.

Embodiments disclosed herein may be implemented in digital electronic circuitry, or in computer software, firmware, or hardware, including the herein disclosed structures and their equivalents. Some embodiments may be implemented as one or more computer programs, i.e., one or more modules of computer program instructions, encoded on a tangible computer storage medium for execution by one or more processors. A computer storage medium may be, or may be included in, a computer-readable storage device, a computer-readable storage substrate, or a random or serial access memory. The computer storage medium may also be, or may be included in, one or more separate tangible components or media such as multiple CDs, disks, or other storage devices. The computer storage medium does not include transitory signals.

As used herein, the term processor encompasses all kinds of apparatus, devices, and machines for processing data, including by way of example a programmable processor, a computer, a system on a chip, or multiple ones, or combinations, of the foregoing. The processor may include special purpose logic circuitry, e.g., an FPGA (field programmable gate array) or an ASIC (application-specific integrated circuit). The processor also may include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) may be written in any form of programming language, including compiled or interpreted languages, declarative or procedural languages, and the program may be deployed in any form, including as a stand-alone program or as a module, component, subroutine, object, or other unit suitable for use in a computing environment. A computer program may, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The computing system disclosed herein may include clients and servers. A client and server are generally remote from each other and typically interact through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving, user input from a user interacting with the client device). Data generated at the client device (e.g., a result of the user interaction) may be received from the client device at the server.

1. A method for supplying advertisements to be displayed on a first media device based on interactions on a second media device, the first media device having a unique identification (UID), the method comprising:
receiving, from the second media device, the UID of the first media device;
receiving an action from the second media device, the action generated during execution of an application on the second media device;
determining an advertisement to serve to the first media device, comprising receiving a content request from the first media device, wherein the content request comprises an advertisement request, and wherein the advertisement is selected at least in part based on the UID received from the second media device; and
serving the advertisement to the first media device.

2. The method of claim 1, wherein determining an advertisement to serve to the first media device further comprises:
in response to receiving the content request, selecting a targeted advertisement to serve to the first media device;
comparing criteria associated with the targeted advertisement to the content request and the received action; and
if the criteria are satisfied, serving the targeted advertisement.

3. The method of claim 2, wherein if the criteria are not satisfied, the method comprises serving a default advertisement.

4. The method of claim 1, wherein the content request comprises:
the UID; and
a channel to which the first media device is tuned.

5. The method of claim 1, further comprising recording an impression when a targeted advertisement is served to the first media device.

6. A computer readable storage medium encoded with a computer program, the program comprising instructions for targeting advertisements to a first media device based on actions on a second media device that, when executed by a processor, causes the processor to:
receive, from the second media device, a unique identification (UID) of the first media device;
receive an action from the second media device, the action generated during execution of an application on the second media device;
receive a content request comprising an advertisement request from the first media device;
in response to receiving the content request, determine an advertisement to serve to the first media device, wherein the advertisement is selected at least based in part on the UID received from the second media device; and
serve the advertisement to the first media device.

7. The computer readable storage medium of claim 6, wherein when the processor determines an advertisement to serve to the first media device, the processor:
selects a targeted advertisement to serve to the first media device;
compares criteria associated with the targeted advertisement to the content request and the received action; and
if the criteria are satisfied, serves the targeted advertisement.

8. The computer readable storage medium of claim 7, wherein if the criteria are not satisfied, the processor serves a default advertisement.

9. The computer readable storage medium of claim 6, wherein the content request comprises:
the UID; and
a channel to which the first media device is tuned.

10. The computer readable storage medium of claim 6, wherein the processor records an impression when a targeted advertisement is served to the first media device.

11. A method for targeting advertisements to a first media device based on actions taken at a second media device; comprising:
receiving a signal broadcast periodically by the first media device at the second media device;
decoding the signal to recover a unique identification (UID) of the first media device;
storing the UID in the second media device;
detecting execution of an action at the second media device;
determining if the executed action is a reportable action;
sending the UID and the reportable action to an advertising server;
receiving an advertisement at the first media device.

12. The method of claim 11, wherein the signal is an audio signal.

13. The method of claim 12, wherein the audio signal is outside a range of human hearing.

14. The method of claim 11, wherein the signal is a visual signal.

15. The method of claim 11, further comprising registering the second media device with the advertising server.

16. A method for targeting advertisements to a first media device based on actions taken at a second media device; comprising:
receiving, at a second media device, a signal sent periodically from the first media device, the signal including a unique identification (UID) of the first media device;
detecting, at the second media device, a trigger for displaying content on the first media device;
sending the UID and the trigger to a content server; and
receiving, from the content server, content for display on the first media device, wherein the content is selected based on the UID and the trigger.

17. The method of claim 16, wherein the signal is broadcast by the first media device.

18. The method of claim 16, wherein the signal is an audio tone outside a range of human hearing.

19. The method of claim 16, wherein the content is an advertisement.

20. A computer readable storage medium encoded with a computer program, the program comprising instructions that, when executed by a processor, causes the processor to perform operations for targeting content to a first media device based on actions on a second media device, the operations comprising:
receiving a signal at the second media device, the signal broadcast periodically by the first media device;
decoding the signal to recover a unique identification (UID) of the first media device;
detecting, at the second media device, a trigger for displaying content on the first media device; and
sending the UID and the trigger to an advertising server.

21. The computer readable storage medium of claim 20, wherein the first media device is a television connected to a set top box, and the second media device is a mobile device.

22. The computer readable storage medium of claim 20, wherein the first media device is an Internet-connected television (iTV), and the second media device is a mobile tablet device.

23. The method of claim 1, further comprising receiving the UID of the first media device from the second media device when the second media device is operating in the vicinity of the first media device.

24. The method of claim 1, further comprising receiving the content request from the first media device when the first media device is scheduled to display an advertisement.
